(19) United States
(12) Patent Application Publication
(10) Pub. No.: US 2011/0088269 A1
(43) Pub. Date: Apr. 21, 2011

(54) Docking Mechanisms for Shaving Razors and Cartridges

(76) Inventors: Vincent Paul Walker, JR., Bridgewater, MA (US); Alejandro Carlos Lee, Cambridge, MA (US); Matthew Corey Cataudella, South Boston, MA (US)

(21) Appl. No.: 12/582,930

(22) Filed: Oct. 21, 2009

(51) Int. Cl. B26B 21/52

(52) U.S. Cl. 30/527

(57) ABSTRACT

A wet shaving razor is provided having a handle, an interconnect member and a cartridge having at least one blade for shaving. The handle has a distal gripping portion and a proximal end portion defining an open area there through. The proximal end portion of the handle has an undercut section. The interconnect member is mounted to the cartridge and includes a latch with a free end that is releasably engaged to the undercut section of the handle. The button has a distal end portion supported by the proximal end portion of the handle and a proximal end portion supported by the free end of the latch such that actuating the button deflects the free end of the latch and disengages the free end from the undercut section of the handle.

### FIELD OF THE INVENTION

The present invention relates to shaving razors and more particularly to shaving razor cartridges having docking mechanisms that removably and/or pivotably couple a shaving razor handle to a shaving cartridge.

### BACKGROUND OF THE INVENTION

In recent years shaving razors with numerous blades have been proposed in the literature and commercialized, e.g., in U.S. Pat. Pub. 2005/0039337 A1 published on Feb. 24, 2005, which generally describes a type of design that has been commercialized globally as the five bladed Fusion™ razor by The Gillette Company.

In emerging markets, such as China and India, the shaving razor of choice is a standard double edge style razor, e.g., in U.S. Pat. No. 3,274,683 issued Sep. 27, 1966, generally describes a typical design used in emerging markets. Consumers in these markets typically do not have the means to purchase the shaving razors that are widely popular in the United States. The standard double edge style razor designs may be economical, but they do not offer the benefits of the designs typically used in more industrial countries.

Shaving consumers in emerging markets typically shave infrequently, sometimes only once or twice a week. There is also little or no availability of running water to rinse or clean a shaving razor and the availability of skin cleansers and pre-shaving and post-shaving shaving aids are limited. Pre-shaving aids may include shaving oils, gels and lotions and post-shaving aids may include after shave gels, lotions and moisturizers. A cup or bowl is typically filled with water and is used to rinse the shaving razor. The shaving razors disclosed in the above mentioned patent application are quite sophisticated having have been designed for Western shaving habits, practices and environments, and thus do not deliver an ideal shaving experience for consumers in emerging markets. The shaving consumer in emerging countries have a much different shaving environment as well as different shaving habits and practices than the typical shaving consumer in more developed countries, such as the United States. Even if a less sophisticated version of the popular five bladed Fusion™ shaving razor was available for these consumers, it would still not provide the optimal shaving experience because of their unique shaving environment, habits, practices and shaving environment.

Interconnect or detachment mechanisms tend to have numerous moving components which have a propensity to fail after many cycles of use. Also if the user drops the shaving razor these mechanisms are the most likely to break. Thus, the user must purchase a replacement handle often before the blade of the shaving razor becomes dull.

It is therefore desirable to provide a shaving razor cartridge having a robust docking mechanism with a minimal number of components that removably and/or pivotably couples a shaving razor handle to a shaving cartridge.

### SUMMARY OF THE INVENTION

In one aspect, the invention features, in general, a shaving razor for wet shaving including a handle, a cartridge and an interconnect member. The handle includes a distal gripping portion and an integral proximal end portion. The cartridge has at least one blade for shaving and is pivotably joined to the interconnect member. The interconnect member is detachably mounted to the integral proximal end portion of the handle.

In another aspect, the invention features, in general, a shaving razor for wet shaving including a cartridge having at least one blade for shaving, a handle and an interconnect member. The handle includes a distal gripping portion and an integral proximal end portion having a pair of opposed arms each having a latch member extending at an acute angle. The interconnect member is pivotably joined to the cartridge and detachably mounted to the proximal end portion of the integral handle. The interconnect member has a housing defining a tapered opening dimensioned to receive the pair of latch members such that inserting the pair of latch members into the housing causes the latch members to deflect and engage an undercut section of the housing.

### BRIEF DESCRIPTION OF THE DRAWINGS

FIG. 1 is a top plan view of a wet shaving razor.

FIG. 2 is an exploded perspective view of the wet shaving razor illustrating a cartridge and handle which may be incorporated in the wet shaving razor shown in FIG. 1.

FIG. 3 is an enlarged exploded perspective view of the cartridge and a proximal end portion of the handle shown in FIG. 2.

FIG. 4 is an enlarged cross section view of the wet shaving razor of FIG. 1, taken generally on the line IV-IV of FIG. 1.

FIG. 5 is a top plan view of another embodiment of a wet shaving razor.

FIG. 6 is an enlarged exploded perspective view of the wet shaving razor illustrating a cartridge and handle which may be incorporated in the wet shaving razor shown in FIG. 5.

FIG. 7A is a side view of a portion of the wet shaving razor of FIG. 5.

FIG. 7B is an enlarged cross section view of the wet shaving razor, taken generally on the line VII-VII, FIG. 7A.

FIG. 8 is a top plan view of yet another embodiment of a wet shaving razor.

FIG. 9 is an enlarged exploded perspective view of the wet shaving razor illustrating a cartridge and handle which may be incorporated in the shaving razor shown in FIG. 9.

FIG. 10 a cross section view of a portion of the shaving razor of FIG. 8, taken generally on the line X-X of FIG. 8.

FIG. 11 a cross section view of the shaving razor of FIG. 8, taken generally on the line XI-XI of FIG. 8.

### DETAILED DESCRIPTION OF THE INVENTION

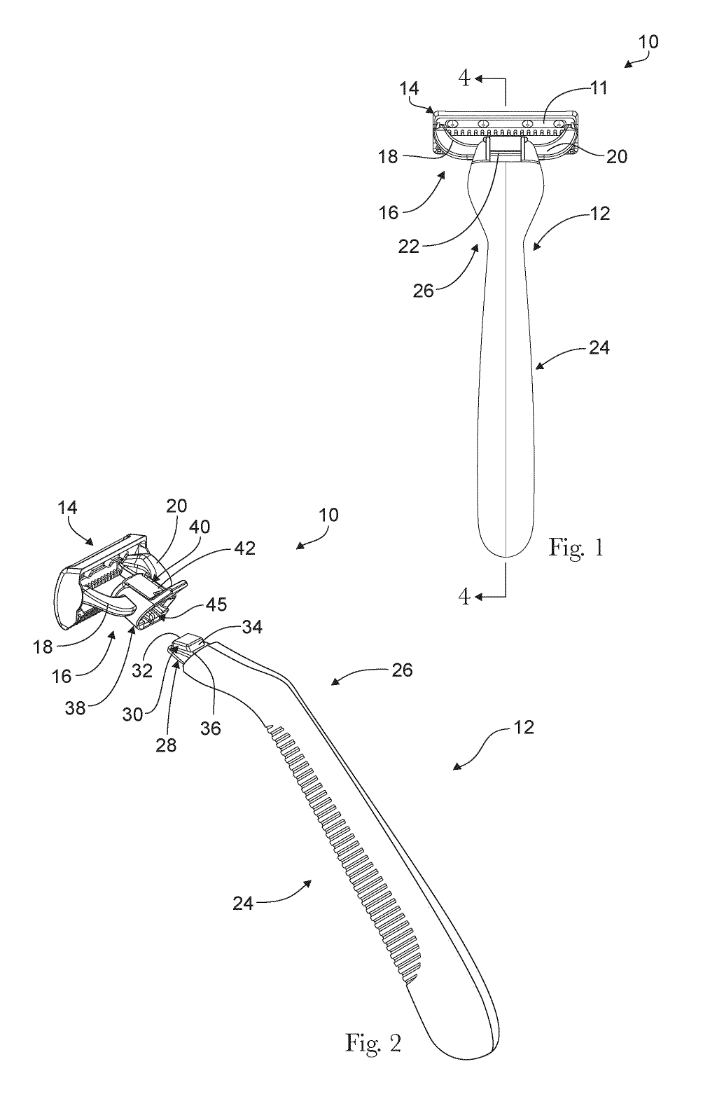

Referring to FIG. 1, one possible embodiment of the present disclosure is shown illustrating a shaving razor 10 having a handle 12 and a cartridge 14 having at least one blade 11 for shaving. The handle 12 may have a distal gripping portion 24 and a proximal end portion 26. In certain embodiments, the cartridge 14 may be detachably and pivotably mounted to the handle 12. In other embodiments the cartridge 14 may be detachably and fixedly mounted to the handle 12. The cartridge 14 may be removed from the handle 12 and replaced with a new cartridge 14 as needed by a user. An interconnect member 16 may detachably join the cartridge 14 to the proximal end portion 26 of the handle 12. The proximal end portion 26 that mounts to the interconnect member 16 may be of an integral, one piece construction which may be molded and/or ultrasonic welded together to form a single component. The proximal end portion 26 that is operatively connected to the interconnect member 16 may not have any moving parts. The term “integral”, unless specified otherwise, is defined as being deficient of or lacking any moving components. Moving components are more prone to failure or breaking and may interfere with the proper function of the handle 12 and the interconnect member 16. Cost is also a significant factor in the purchasing decision of consumers in emerging markets. Many shaving razors offer detachable cartridges that pivot, however these designs often require numerous components which increase the complexity and cost of the shaving razor. Detachment mechanisms with numerous moving parts can also trap water, shaving aids and debris, which may interfere with or corrode various components of the detachment mechanism, such as springs. The detachment mechanism may also be difficult clean and wash out, which may lead to the growth of microorganisms.

The interconnect member 16 may be permanently and pivotably joined to the cartridge 14, which may provide several advantages. The interconnect member 16, rather than the handle 12, may have moving components which can fatigue and fail with prolonged use, which happens with all shaving razors with attachment mechanisms. Since the cartridge 14 is replaced when the blade 11 become dull, the cartridge 14 and thus the interconnect member 16 are replaced before the interconnect member 16 is exposed to a number of fatigue cycles which may result in failure of the connection between the cartridge 14 and the handle 12. By having the moving components that are susceptible to wear or breakage located on the cartridge 14 (for example, the interconnect member 16) the user may never need to purchase a replacement handle 12. Another possible advantage of having an integral handle 12 with no moving components is that after market handle manufactures' are more likely to manufacture custom replacement handles, since the complexity of the handle is greatly reduced and little or no additional assembly work is necessary. A custom handle can be molded, machined or cast using high end materials, such a chrome and various precious metals or plating, for a fraction of the cost of a custom handle requiring various connection mechanisms with moving and/or fragile components.

The interconnect member 16 may provide for single point docking of the handle 12 to the cartridge 14. Single point docking requires only a single area for connection, for example, one area or component on the handle 12 and one component or area on the interconnect member 16. Single point docking simplifies the attachment and detachment of the handle 12 from the cartridge 14 because multiple areas or components on the handle 12 and multiple areas or components on the cartridge 14 do not need to all accurately align and engage for proper attachment and detachment. As will be described in greater detail below, the interconnect member 16 may be provided with a release tab 22 to facilitate the disengagement of the cartridge 14 from the handle 12. The release tab 22 may allow the user to remove the cartridge 14 from the handle 12 with a single digit and/or a single action without the complexity or extra components such as an ejector or release button, which typically requires a spring plus additional components. In certain embodiments, the release tab 22 may eject or project the interconnect member 16 and cartridge 14 from the handle 12. The ability of the release tab 22 to eject or project the cartridge from the handle allows the user to remove and dispose of the cartridge 14 with a single hand.

In certain embodiments, the interconnect member 16 may have a pair of arms 18 and 20 that securely and pivotably connect to the cartridge 14. The opposing arms 18 and 20 may be relatively long and with a smaller wall thickness, and thus may be more prone to fatigue or failure. By locating the arms 18 and 20 on the cartridge 14 (which is disposed after a limited number of uses) the handle 12 may never need to be replaced due to components failing. The opposing arms 18 and 20 may allow for an open space or window below the cartridge 14, which may improve the ability for water to rinse out the cartridge 14 after shaving. The interconnect member 16 may be a single integral component which is capable of detachably and pivotably coupling the cartridge 14 to the handle 12, without the need of separate components assembled to the handle 12 or the cartridge 14. The handle 12, the cartridge 14 and the interconnect member 16 may be molded from polymers such as high impact polystyrene (HIPS), but other semi-rigid polymers such as polypropylene (PP) and acrylonitrile butadiene styrene (ABS) may also be used. Alternatively, the handle 12 may be composed of more durable materials such as metals, composites, more rigid plastics or any combination thereof.

Now turning to FIG. 2, an exploded perspective view of the shaving razor 10 is shown illustrating the cartridge 14 and handle 12. The handle 12 may include a distal gripping portion 24 and a proximal end portion 26. The proximal end portion 26 of the handle 12 may be of generally solid construction. A generally solid proximal end portion 26 may have no moving components or features such as, apertures or holes, which may trap shaving aids or debris. Trapped shaving aids or debris may adversely affect the proper function of a release mechanism, making it difficult to eject a razor cartridge from a handle. The proximal end portion 26 may include a protrusion 28 with an enlarged latch member 30 having a tapered leading end portion 32 and a tapered trailing end portion 34. The tapered trailing end portion 34 of the enlarged latch member 30 may be spaced apart from a front wall 36 of the proximal end portion 26 of the handle 12. The interconnect member 16 may include a housing 38 having a latch 40 with a free end 42 that engages the protrusion 28. A tab member 22 having a first position and a second position may extend from the free end 42. Although a tab member 22 is shown, other release mechanisms such as buttons, knobs, pins, levers or dials may be used. The housing 38 may define an opening 45 dimensioned to receive the protrusion 28 of the handle 12. As will be described in greater detail below, the tapered leading end portion 32 may aid in guiding and inserting the protrusion 28 into the housing 38.

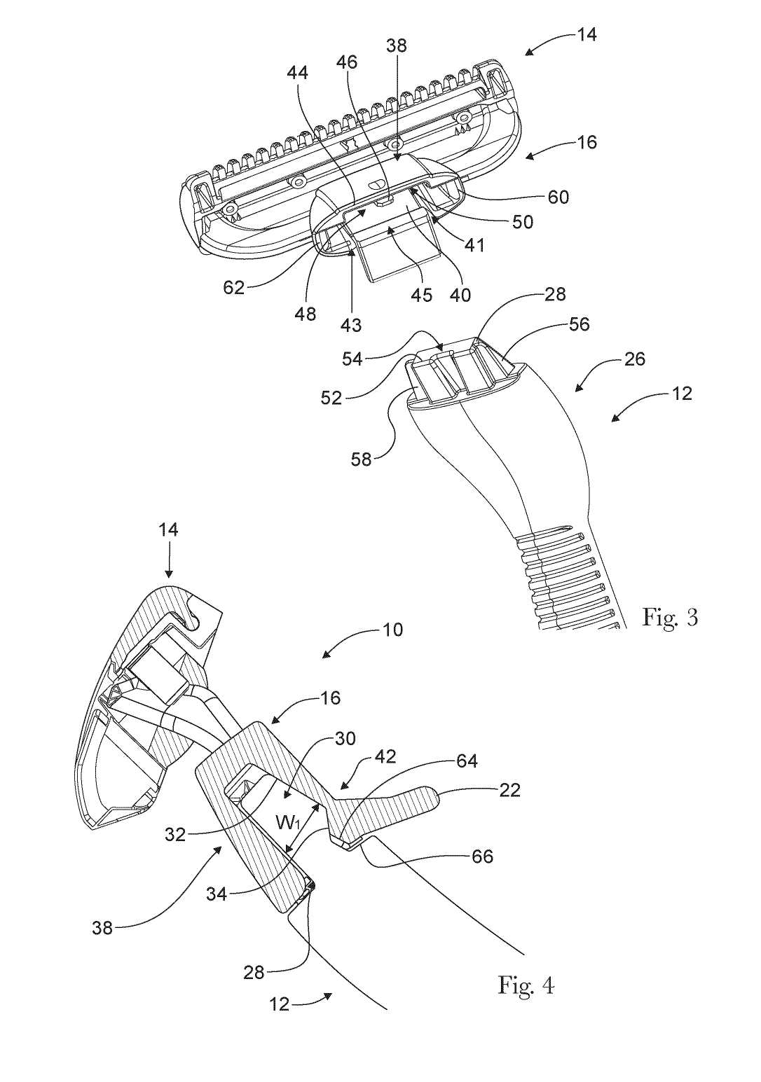

Referring to FIG. 3, an enlarged perspective view of the cartridge 14 and the proximal end portion 26 of the handle 12 is illustrated. The proximal end portion 26 of the handle 12 may allow for a “one way” with the interconnect member 16, thus the cartridge 14 is prevented from being attached incorrectly (for example, upside down). One way loading creates a predetermined loading configuration, thus the user can not incorrectly attach the handle 12 to the cartridge 14. The “one way” loading of the cartridge 14 may be facilitated by housing 38 and/or the proximal end portion 26 of the handle 12 having an asymmetrical geometry. Generally, cartridges have a tendency to disengage from a handle if the user does not assemble them properly, which may result in injury to the user during shaving. The one way loading of the cartridge 14 is straightforward and intuitive to use, especially for consumers who have never used a removable cartridge. As will be described in greater delay below, one way loading may also be facilitated by features such as rails or channels. The housing 38 may include the latch 40, a first wall 44 and a pair of side walls 60 and 62 that define an opening 45. Although the latch 40 is shown with a pair of slits 41 and 43, slits 41 and 43 are not required for the function of latch 40. The housing 38 may include a first wall 44 having a tapered guide member 46 which may aid in the alignment and securing of the handle 12 to the housing 38. The first wall 44 and the guide member 46 may define a pair of slots 48 and 50 that are dimensioned to receive at least a portion of the protrusion 28 of the handle 12.

The protrusion 28 of the handle 12 may have a first wall 52 that defines a tapered slot 54 that is dimensioned to receive the tapered guide member 46 of the housing 38. The tapered slot 54 and the tapered guide member 46 may facilitate “one way” loading of the cartridge 14 to the handle 12. The assembly of the tapered slot 54 of the handle 12 and the tapered guide member 46 of the housing 38 may result in a tapered interlock which secures the protrusion 28 of the handle 12 within the housing 38 of the interconnect member 16. The taper angle of the tapered slot 54 and the tapered guide member 46 may be about ⅛ of a degree per side to about 10 degrees per side, or even about 1 degree per side to about 5 degrees per side. The taper angle of the tapered slot 54 and the tapered guide member 46 may also facilitate the proper alignment and assembly of the handle 12 to the cartridge 14.

The protrusion 28 of the handle 12 may have a first and second lateral projections 56 and 58 that engage the corresponding pair of side walls 60 and 62 of the housing 38. The first and second lateral projections 56 and 58 and the corresponding side walls 60 and 62 of the housing 38 may also be tapered to create a tapered interlock, as previously described. The first and second lateral projections 56 and 58 and the tapered slot 54 of the protrusion 28 may aid in rigidly securing the protrusion 28 within the housing 38 and prevent the cartridge 14 from unintentionally disengaging from the handle 12 during shaving.

Referring to FIG. 4, an enlarged cross section view of the shaving razor 10 is shown, taken generally on the line IV-IV of FIG. 1. As shown in FIG. 4, the cartridge 14 is secured to the handle 12 by use of the interconnect member 16. The enlarged latch member 30 may have dimension, for example “w₁”, that is greater than the width of the housing 38 in a neutral position, such that inserting the enlarged latch member 30 into the housing 38 causes the free end 42 to deflect from its original or neutral position. The free end 42 may have a flange member 64 that rides along the leading end portion 32 of the enlarged latch member 30. The leading end portion 32 may act as a ramp to facilitate the deflection of the free end 42. The flange member 64 may clear the leading end portion 32 and the trailing end portion 34 of the enlarged latch member 30 and engage the protrusion 28 of the handle 12. The flange member 64 may become securely positioned between the trailing end portion 34 of the enlarged latch member 30 and a front wall 66 of the distal end portion 26 of the handle 12. The trailing end portion 34 of the enlarged latch member 30 may have a steeper incline or taper than the leading end portion 32 to prevent the free end 42 and flange member 64 from disengaging with the protrusion 28. Once the flange 64 clears the trailing end 34, a sensory feedback may result, such as a click sound, as the flange member 64 of the housing 38 snaps against the protrusion 28 and back to its original or the first position.

The release tab 22 may be joined to the free end 42 of the interconnect member 16 to facilitate the disengagement of the cartridge 14 from the proximal end portion of the handle 12. The user may lift or push the release tab 22 to the second position to disengage the flange member 64 from the protrusion 28. The flange member 64 may flex to an extended position as the flange member rides along the tapered trailing portion. Once the flange member 64 clears the tapered trailing portion, the free end 42 may flex back to its original position, thus ejecting the cartridge from the protrusion 30 of the handle 12. The tapered or ramp geometry of the leading end portion 32 may facilitate the ejecting of the cartridge 14 from the handle 12. The release tab 22 may also facilitate mounting the protrusion 28 on the housing 38 by opening up (increasing the width) the housing to aid in the insertion of the protrusion 28.

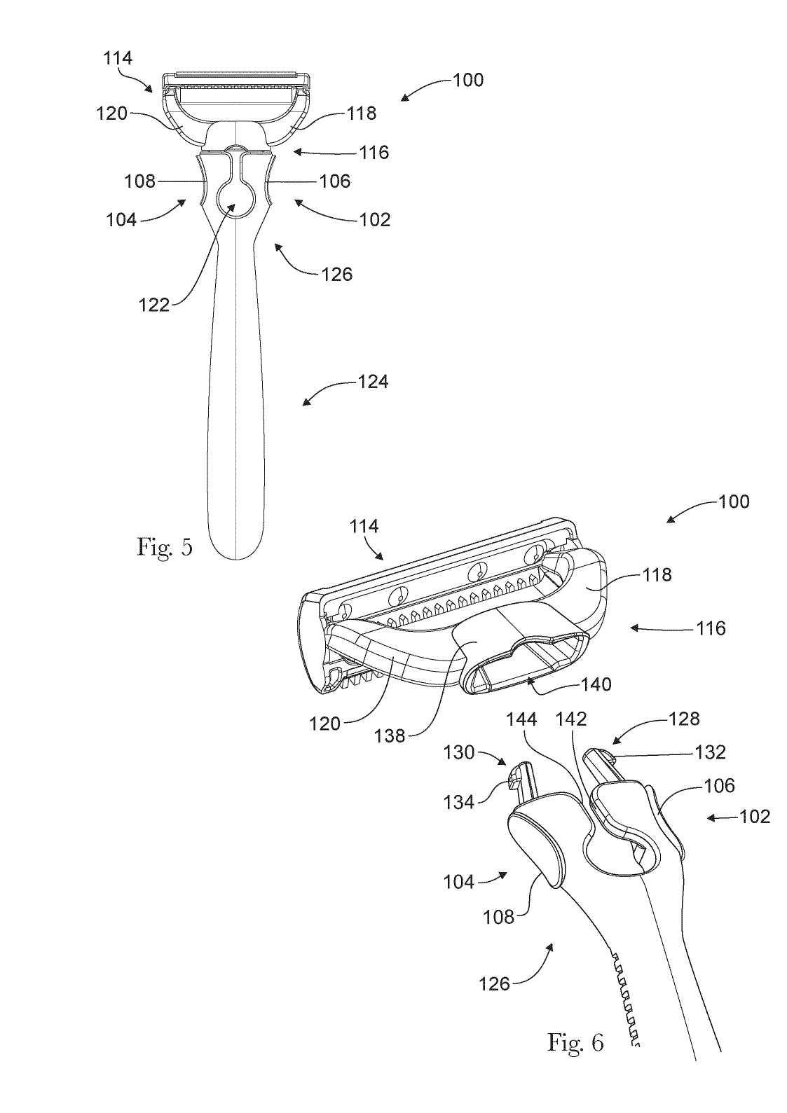

Referring to FIG. 5, another possible embodiment of the present disclosure is shown illustrating a shaving razor 100 having a handle 112 and a cartridge 114. The handle 112 may include a distal gripping portion 124 and a proximal end portion 126. In certain embodiments, the cartridge 114 may be detachably and pivotably mounted to the proximal end portion 126 of the handle 112. In other embodiments the cartridge 114 may be detachably and fixedly mounted to the handle 112. The cartridge 114 may be removed from the proximal end portion 126 of the handle 112 and replaced with a new cartridge 114 as needed by a user.

An interconnect member 116 may be provided to detachably join the cartridge 114 to the proximal end portion 126 of the handle 112. As will be described in greater detail below, the proximal end portion 126 of the handle 112 may include a pair of flexible arms 102 and 104 that facilitate the engagement and disengagement of the interconnect member 116 and the cartridge 114 from the handle 112. The pair of flexible arms 102 and 104 may define a generally key hole shaped slot 122 that provides for increased strength, durability and flexibility of the arms 102 and 104. The pair of arms 102 and 104 may each be provided with an enlarged finger pad 106 and 108. The enlarged finger pads 106 and 108 may have a generally oval geometry with a contoured or concave profile. The enlarged finger pads 106 and 108 may allow more force to be applied to the pair of flexible arms 102 and 104, while dispersing the force applied to the user's fingers, which may result in less discomfort during the attachment and removal of the cartridge 114 from the handle 112.

In certain embodiments, the interconnect member 116 may have a pair of arms 118 and 120 that securely and pivotably connect to the cartridge 114. The opposing arms 118 and 120 may allow for an open space or window below the cartridge 114, which may improve the ability for water to rinse out the cartridge 114 after shaving. The interconnect member 116 may be a single integral component which is capable of detachably and pivotably coupling the cartridge 114 to the handle 112, without the need of separate components assembled to the handle 112 or the cartridge 114. The handle 112, the cartridge 114 and the interconnect member 116 may be molded from polymers such as high impact polystyrene (HIPS), but other semi-rigid polymers such as polypropylene (PP) and acrylonitrile butadiene styrene (ABS) may also be used. Alternatively the handle 112 may be composed of more durable materials such as metals, composites, more rigid plastics or any combination thereof.

Now turning to FIG. 6, an exploded perspective view of the shaving razor 100 is shown illustrating the assembly/disassembly of the cartridge 114 and the handle 112. The pair of flexible arms 102 and 104 of the proximal end portion 126 of the handle 112 may each have a latch member 128 and 130 with a catch portion 132 and 134, respectively. The latch members 128 and 130 may be non parallel to each other and extend from the pair of flexible arms 102 and 104 at an acute angle projecting toward each other. The flexible arms 102 and 104 may each have an inner stop surface 142 and 144 which may contact each other as the flexible arms 102 and 104 are compressed together. The finger pads 106 and 108 may allow a user to apply more force to the flexible arms 102 and 104, thus it is possible to over compress the flexible arms 102 and 104 either instantaneously or over many repeated uses. The flexible arms 102 and 104 may fatigue and loose their plastic memory. If the arms 102 and 104 loose their plastic memory they will not return to their original positions which may result in a loose and unsecure attachment of the cartridge 114 to the handle 112. The inner surfaces 142 and 144 may act as a stop to prevent over compression of the pair of flexible arms 102 and 104, thus preventing premature failure of the arms 102 and 104. The inner surfaces 142 and 144 may contact each other when the arms 102 and 104 are sufficiently compressed to allow assembly of the handle 112 to the interconnect member 116.

The cartridge 114 may be pivotably connected to the interconnector member 116 via the pair of opposing arms 118 and 120. The pair of opposing arms 118 and 120 may extend arcuately from the cartridge 114 to a housing 138. The housing 138 may define a tapered opening 140 that is dimensioned to receive the latch members 128 and 130 and cause them to deflect. The latch members 128 and 130 may each have a free end which acts as cantilever beam to facilitate the deflection of the latch members 128 and 130 as they are inserted into the housing 138.

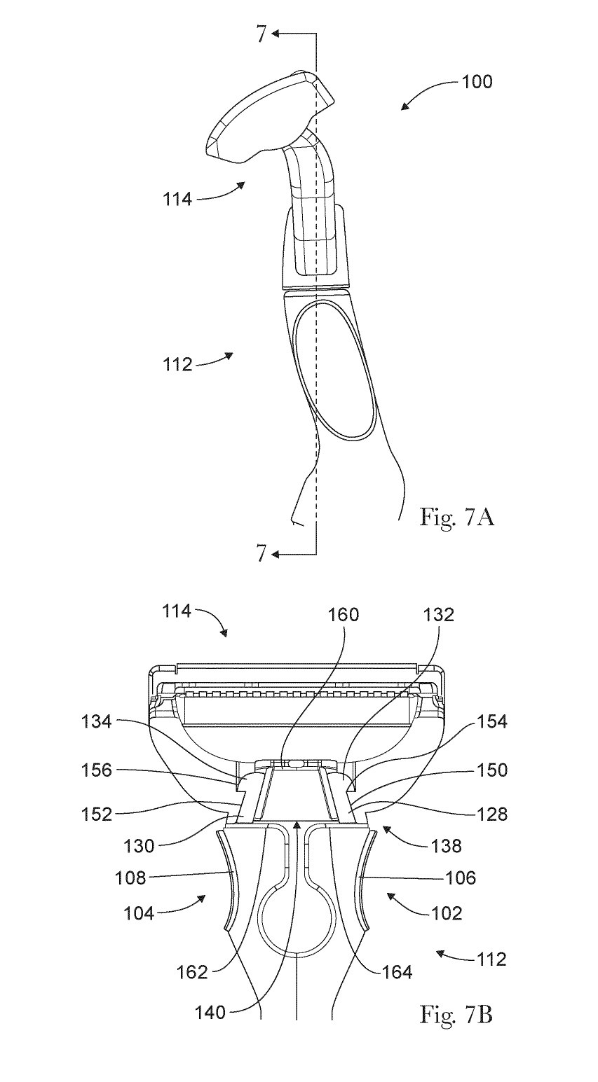

Referring to FIGS. 7A and 7B, the shaving razor 100 is shown with the cartridge 114 mounted to the handle 110. FIG. 7B illustrates an enlarged cross section view of a portion of the shaving razor 100, taken generally on the line VII-VII of FIG. 5. As shown in FIG. 7B, the latch members 128 and 130 are fully inserted into the housing 138 and the cartridge 114 is secured to the handle 112. The flexible arms 102 and 104 may be compressed towards each other to insert the latch members 128 and 130 into the tapered opening 140 of the housing 138. To aid in the compression of the flexible arms 102 and 104, the user may press against the finger pads 106 and 108 as the latch members 128 and 130 are inserted into the tapered opening 140 of the housing 138.

The tapered opening 140 of the housing 138 may have a width dimension between a pair of opposing inner walls 150 and 152, that is smaller than a width dimension between the pair of catch portions 132 and 134, such that inserting the catch portions 132 and 134 into the housing 138 causes them (and/or the latch members 128 and 130) to deflect. The catch portions 132 and 134 of the latch members 128 and 130 may ride along the inner walls 150 and 152 of the housing 138 and engage one or more undercut sections 154 and 156 of the inner wall 150 and 152. The latch members 128 and 130 may be inserted into the housing 138 until the housing 138 contacts a front wall 162 and 164 of the flexible arms 102 and 104 of the handle 112. The front walls 162 and 164 of the flexible arms 102 and 104 may act as a stop to prevent the latch members 128 and 130 from being inserted too far into the housing 138 and contacting a rear wall 160 of the housing 138. The rear wall 160 may effect or interfere with the engagement or disengagement of the latch members 128 and 130 if they are inserted too far into the housing 138. The undercuts 154 and 156 may engage the respective catch portions 132 and 134 of the latch members 128 and 130 and prevent the latch members 128 and 130 from pulling out of the housing 138.

Once the catch portions 132 and 134 engage the undercut sections 154 and 156 of the housing 138, the user may release the finger pads 106 and 108. Once the force on the flexible arms 102 and 104 is removed, the flexible arms 102 and 104 and the latch members 128 and 130 will attempt to return or spring back to their respective original positions. However, the housing 138 may be dimensioned to prevent the latch members 128 and 130 (and thus the flexible arms 102 and 104) from returning to their full respective original positions, thus causing the latch members 128 and 130 to exert a force against the inner walls 150 and 152 of the housing. The catch portions 132 and 134 may also exert a force against the undercut sections 154 and 156 of the housing 138. The force exerted against the housing 138 may be increased by increasing the width between the latch members 128 and 130 or decreasing the width between the inner walls 150 and 152 (which may also include the undercut sections 154 and 156). The interconnect member 116 may be secured more rigidly to the handle 112 by increasing the interference between the latch members 128 and 130 and the housing 138.

The inner walls 150 and 152 and the latch members 128 and 130 may be tapered such as a tapered interlock is created when they are assembled to ensure proper alignment and attachment of the housing 138 to the handle 112. The housing 138 may become rigidly secured between the catch portions 132 and 134 and the front wall 162 of the proximal end portion of the handle 112 and prevent unintended disassembly during shaving.

The user may detach the cartridge 114 from the handle 112 by compressing the flexible arms 102 and 104 and pulling the handle 112 away from the cartridge 114 such the catch portions 132 and 134 clear the undercut sections 154 and 156 of the housing 138. The cartridge 114 may be discarded and another cartridge 114 may then be mounted to the handle 112 as previously described.

Referring to FIG. 8, another possible embodiment of the present disclosure is shown illustrating a shaving razor 200 having a handle 212 and a cartridge 214. The handle 212 may include an elongated gripping portion 224 and an enlarged proximal end portion 226. In certain embodiments, the cartridge 214 may be detachably and pivotably mounted to the enlarged proximal end portion 226 of the handle 212. In other embodiments the cartridge 14 may be detachably and fixedly mounted to the handle 12. The cartridge 214 may be removed from the enlarged proximal end portion of the handle 212 and replaced with a new cartridge 214 as needed by a user. An interconnect member 216 may be provided to detachably join the cartridge 214 to the proximal end portion 226 of the handle 112. The interconnect member 216 may include a pair brace members 206 and 208 that extend partially around the enlarged proximal end portion 226 of the handle 212. The brace members 206 and 208 may minimize any rocking or tipping of the cartridge 214 relative the handle 212. As will be described in greater detail below, the proximal end portion 226 of the handle 212 may include a release mechanism, such as a button 222 to facilitate the engagement and disengagement of the interconnect member 216 and the cartridge 214 from the handle 212. The button 222 may be actuated substantially perpendicular to a longitudinal axis VIII-VIII of the shaving razor 200 and/or the button 222 may be actuated and displaced along the longitudinal axis VIII-VIII.

In certain embodiments, the interconnect member 216 may have a pair of opposing arms 218 and 220 that securely and pivotably connect to the cartridge 214. The opposing arms 218 and 220 may allow for an open space or window below the cartridge 214, which may improve the ability for water to rinse out the cartridge 214 after shaving. The interconnect member 216 and the button 222 may be manufactured or molded as a single component (or molded separately and later assembled) which is capable of detachably and pivotably coupling the cartridge 214 to the handle 212, without the need of separate components assembled to the handle 212 or the cartridge 214, such as a spring member. The handle 212, the cartridge 214, the button 222 and the interconnect member 216 may be molded from polymers such as high impact polystyrene (HIPS), but other polymers such as polypropylene (PP) and acrylonitrile butadiene styrene (ABS) may also be used. Alternatively the handle 212 and/or the button 222 may be composed of more durable materials such as metals, composites, more rigid plastics or any combination thereof.

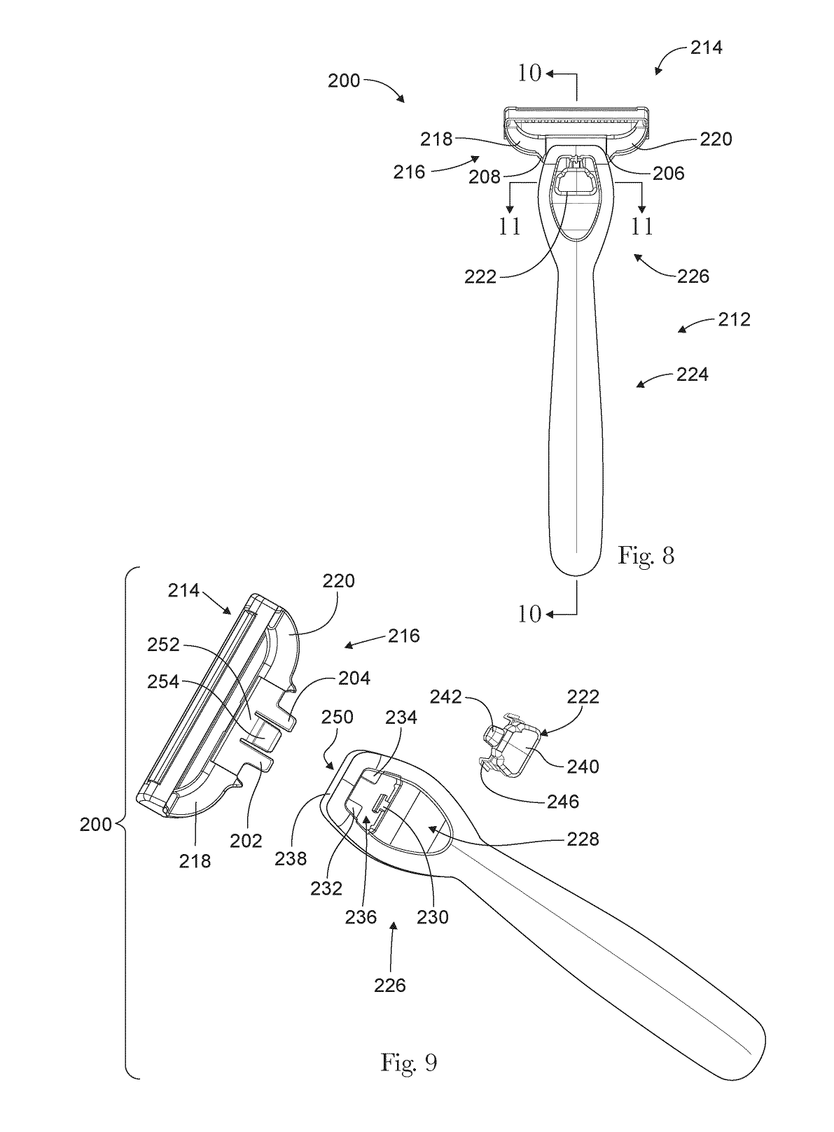

Now turning to FIG. 9, an exploded perspective view of the shaving razor 200 is shown illustrating the assembly of the cartridge 214, button 222 and handle 212. In certain embodiments the button 222 may be injection molded as a single piece with the handle 212. In other embodiments the button 222 may be molded separately and assembled to the handle 212. The enlarged proximal end portion 226 of the handle 212 may have a generally oval shape defining a recessed surface 228. The recessed surface 228 may include a tab member 230 and a pair of slotted projections 232 and 234. The tab member 230 may support the button 222 and act as a return element or a biasing mechanism for actuation of the button 222. The recessed surface 228 may define an opening 236 extending there through. A front wall 238 of the enlarged proximal end portion 226 may define a slot 250 extending through the front wall 238 and in communication with the opening 236 and the slotted projections 232 and 234. The slotted projection 232 and 234 may be a continuation of the front wall 238.

The button 222 may include a proximal end portion 242, a distal end portion 240 and a pair of latches 244 and 246 between the proximal and distal end portions. The opening 236 of the enlarged proximal end portion 226 of the handle 212 may be dimensioned to receive at least a portion of the button 222 and the pair of latches 244 and 246. The pair of latches 244 and 246 may engage a bottom surface of the enlarged proximal end portion 226 of the handle 212. When the button 222 is positioned within the opening 230, the projection 242 of the button 222 may be situated between the pair of slotted projections 232 and 234 (as seen in FIG. 8).

The pair of opposing arms 218 and 220 of the interconnect member 216 may follow a generally arcuate path from the cartridge 214 to a pair of guide members 202 and 204. A latch 252 having a free end 254 may be positioned between the pair of guide members 202 and 204. The slot 250 extending into the front wall 238 of the enlarged proximal end portion 226 of the handle 212 may be dimensioned to receive the latch 252 and the pair of guide members 202 and 204. The slotted projections 232 and 234 may receive the guide members 202 and 204, respectively. The pair of guide members 202 and 204 may act as support members to facilitate the deflection of the free end 254 relative to the pair of guide members 202 and 204.

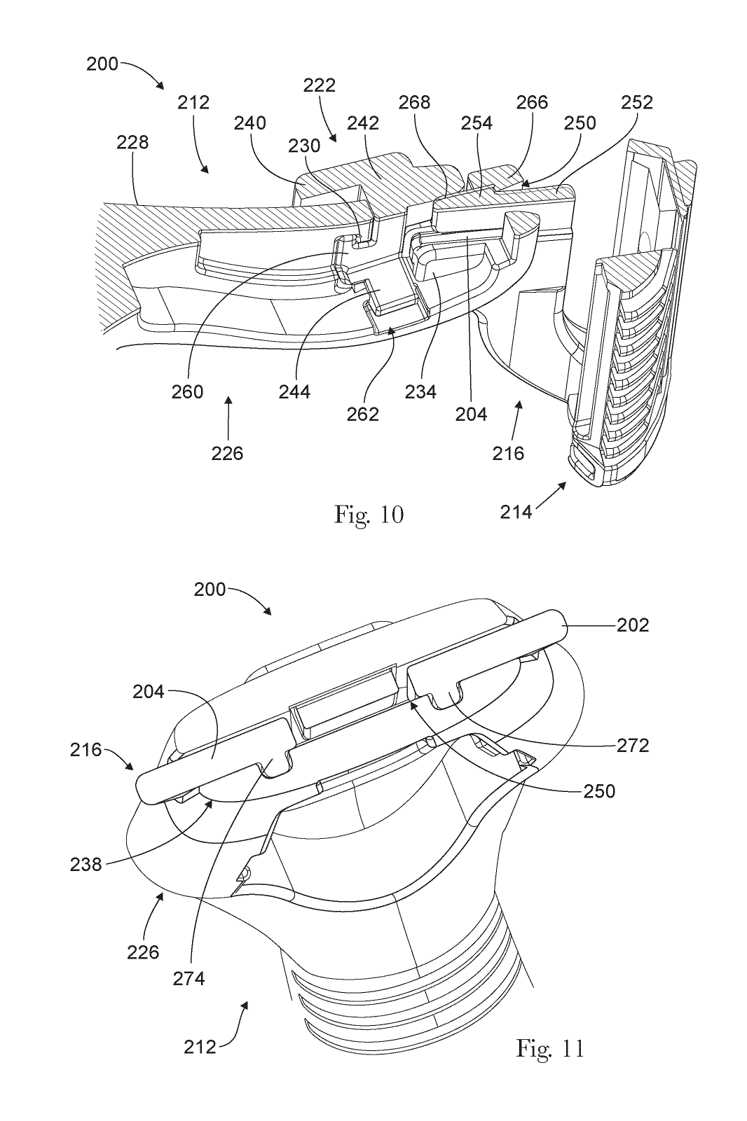

Referring to FIG. 10, a bottom perspective cross section view of the shaving razor 200, generally taken on the line X-X of FIG. 8, is illustrated. The button 222 may have a bottom surface 260 that is dimensioned to receive the tab member 230. The tab member 230 of the handle 212 and the bottom surface 260 of the button 222 may have a key fit, such as a “T” shaped geometry. The tab member 230 may act as a support member and also as a return of spring element which biases the button 222 in a non actuated position. The distal end portion 240 of the button 222 may be supported by the recessed surface 228 and the tab member 230. The proximal end portion 242 of the button 222 may be supported by the free end 254 of the interconnect member 216. The tab member 230 and the free end 254 may apply a biasing force against the button 222.

The latch members 244 (246 not shown for clarity) may engage a respective undercut section 262 of the enlarged proximal end portion 226 of the handle 212 to secure the button 222 to the handle 212. The undercut section 266 may guide the latch member 244 as it travels in a downward direction when the button 222 is actuated. The undercut section 266 may also prevent the latch member 244 from disengaging from the handle 212 when the button 222 moves in an upward direction. The distal end portion 240 of the button 222 may contact the recessed surface 228 of the handle to prevent disengagement of the button 222. The latch member 246 and a corresponding undercut section 264 of the enlarged proximal end portion 226 are not shown, but function substantially the same way.

The cartridge 214 may be mounted to the handle 212 by inserting the interconnect member 216 into the slot 250 of the enlarged proximal end portion 226 such that the guide members 202 and 204 are received by the respective slotted projections 232 and 234 (232 and 202 not shown for purposes of clarity). As the latch 252 is inserted, the free end 254 may deflect and engage an undercut 266 of the front wall 238 to secure the cartridge 214 to the handle 212. When the latch 252 is inserted, the free end 254 may contact a bottom surface 268 of the button 222, causing the proximal end portion 242 of the button 222 to toggle into a first position. The free end portion 254 acting on the bottom surface 268 of the button 222 may bias the button 222 in the first toggle position and may also act as a spring member to provide the user with feedback as the button 222 is actuated. In the first toggle position, the distal end portion 240 of the button may contact the recessed surface 228 of the handle 212 at an angle, as shown in FIG. 10.

The user may release the cartridge 214 from the handle 212 by actuating the button 222 to a second toggle position. In the second toggle position, the distal end portion 240 of the button 222 may more fully contact the recessed surface 228 of the handle 212, as compared with the first toggle position. When the button 222 is actuated, the bottom surface 268 of the button 222 may deflect the free end 254 of the latch 252, allowing the free end 254 to clear the undercut 266. Once the free end 254 clears the undercut 266, the cartridge 214 may release or expel from the handle 212 due to the force generated by the deflection of the free end 254. After removal of the cartridge 214, another cartridge 214 may then be mounted to the handle 212 as previously described.

Referring to FIG. 11, a cross section view of the shaving razor 200, generally taken on the line XI-XI of FIG. 8, is illustrated. The cartridge 214 (not shown) may be mounted to the handle 212 by inserting the interconnect member 216 into the slot 250 of the enlarged proximal end portion 226. One or more of the guide members 202 and 204 may be asymmetrically shaped to provide a one way loading feature 272 and 274, respectively. The one way loading features 272 and 274 may prevent the interconnect member 216 from being mounted to the handle 212 improperly (e.g., upside down). The one way loading features 272 and 274 may also impart lateral stabilization (e.g., side to side or up and down) of the interconnect member 216 relative to the handle 212. The increase lateral stabilization may provide a more secure connection between the interconnect member 216 and the handle 212 which reduces undesired movement of the cartridge 214 (not shown) which may lead to nicks and an uncomfortable shave.

The one way loading features 272 and 274 may include rails, channels or other features positioned on a top surface or a bottom surface of one or more of the guide members 202 and 204. The slot 250 may have a corresponding asymmetrical geometry that may extend into one or more of the slotted projections 232 and 234 (not shown). The slot 250 and the slotted projections 232 and 234 may be dimensioned to receive the one way loading features 272 and 274, such that the interconnect member 216 can be mounted to the handle 212 only in a single orientation. One way loading provides a more intuitive design to the consumer and reduce the possibility of improper loading which may result in damage to the handle 212 and/or the interconnect member 216. Even if the consumer has never used or is unfamiliar with the shaving razor 200, the consumer will be able to quickly, properly and effortlessly attach and replace cartridges 214 (not shown) utilizing the interconnect member 216.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor comprising:
a handle including a distal gripping portion and a proximal end portion;
a cartridge having at least one blade for shaving;
an interconnect member pivotably joined to the cartridge, and detachably mounted to the proximal end portion of the handle; and
a release mechanism having a first position and a second position, the release mechanism being joined to the interconnect member for disengaging the cartridge from the handle.

2. The shaving razor of claim 1 wherein the release mechanism is a tab member that ejects the interconnect member and the cartridge from the housing.

3. The shaving razor of claim 1 wherein the interconnect member includes a housing having a latch.

4. The shaving razor of claim 3 wherein the proximal end portion of the handle includes a protrusion with an enlarged latch member dimensioned to fit within the housing such that inserting the enlarged latch member into the housing causes the latch of the housing to deflect and engage the protrusion.

5. The shaving razor of claim 4 wherein the protrusion defines a tapered slot dimensioned to receive a tapered projection on the housing.

6. The shaving razor of claim 5 wherein the release mechanism comprises a tab member joined to the housing such that actuating the tab member causes the latch of the housing to disengage the protrusion and release from the handle.

7. A shaving razor comprising:
a handle including a distal gripping portion and a proximal end portion having a protrusion;
a cartridge having at least one blade for shaving;
an interconnect member pivotably joined to the cartridge and detachably mounted to the proximal end portion of the handle, wherein the interconnect member includes a housing having a free end that engages the protrusion of the handle; and
a release mechanism positioned on the housing.

8. The shaving razor of claim 8 wherein the release mechanism comprises a tab member joined to the free end of the housing such that actuating the tab member causes the latch of the housing to disengage the protrusion and release from the handle.

9. The shaving razor of claim 9 wherein the tab member and the housing are a single component.

10. A shaving razor comprising:
a cartridge having at least one blade for shaving;
a handle including a distal gripping portion and an proximal end portion having a pair of opposed arms each having a latch member extending at an acute angle; and
an interconnect member pivotably joined to the cartridge and detachably mounted to the proximal end portion of the integral handle, the interconnect member including a housing defining a tapered opening dimensioned to receive the pair of latch members such that inserting the pair of latch member into the housing causes the latch members to deflect and engage an undercut section of the housing.

11. The shaving razor of claim 10 wherein the pair of opposed arms are integral with the handle.

12. The shaving razor of claim 11 wherein each arm of the handle includes a contoured finger pad to facilitate compression of the arms.

13. The shaving razor of claim 11 wherein each of the pair of opposed arms includes an inner stop surface that contact one another to prevent over compression of the arms.

14. The shaving razor of claim 13 wherein the pair of opposed arms define a key hole shaped slot.

15. A shaving razor comprising:
a cartridge having at least one blade for shaving;
a handle having a distal gripping portion and a proximal end portion defining an open area there through, the proximal end portion having an undercut section;
an interconnect member mounted to the cartridge, the interconnect member including a latch with a free end releasably engaged to the undercut section of the handle; and
a button having a distal end portion supported by the proximal end portion of the handle and a proximal end portion supported by the free end of the latch such that actuating the button deflects the free end of the latch and disengages the free end from the undercut section of the handle.

16. The shaving razor of claim 15, wherein latch member is positioned between a pair of support members and the proximal end portion of the handle includes a front wall defining a slot dimensioned to receive the pair of support members.

17. The shaving razor of claim 15 wherein the interconnect member includes a pair of brace members that extend at least partially around the proximal end portion of the handle.

18. The shaving razor of claim 15 wherein the interconnect member is pivotably mounted to the cartridge.

19. The shaving razor of claim 15 wherein the proximal end portion of the handle includes a tab member that extends into the open area and supports the distal end portion of the button.

20. The shaving razor of claim 15 wherein the button has a first toggle position in which the distal end portion of the button is positioned at a first angle relative to the proximal end portion of the handle.

21. The shaving razor of claim 15 wherein the button has a second toggle position in which the distal end portion of the button is positioned at a second angle relative to the proximal end portion of the handle, wherein the second angle is more parallel than the first angle.
